(19) United States
(12) Patent Application Publication
(10) Pub. No.: US 2023/0337333 A1
(43) Pub. Date: Oct. 19, 2023

(54) RESISTIVE FOIL HEATER

(71) Applicant: Minco Products, Inc., Minneapolis, MN (US)

(72) Inventors: Robert C. Woitalla, Layton, UT (US); Benjamin Simmer, Hugo, MN (US); Craig Marusic, Andover, MN (US)

(73) Assignee: Minco Products, Inc., Minneapolis, MN (US)

(21) Appl. No.: 18/007,913

(22) PCT Filed: Jun. 7, 2021
(86) PCT No.: PCT/US2021/036140

§ 371 Date: Apr. 20, 2023

Related U.S. Application Data
(60) Provisional application No. 63/035,022, filed on Jun. 5, 2020.

(51) Int. Cl. H05B 3/36

(52) U.S. Cl. CPC H05B 3/36; H05B 2203/011

(57) ABSTRACT

An improved resistive foil heater is notionally provided. The improved heater includes a coverlay, a base, an etched composite panel intermediate the coverlay and the base, transition tabs, and lead wires. The etched composite panel is characterized by a foil element, and a substrate for supporting the foil element, and the panel is adapted for passage of the transition tabs in furtherance of functional union with the lead wires. The foil element is characterized by an etched resistive foil heater, and associated transition pads. The transition tab is united to/with the transition pads of the foil element of the etched composite panel, the lead wires functionally united with the etched resistive foil heater via the transition tabs.

This is an international patent application filed under U.S.C. §363 claiming priority under 35 U.S.C. §120 to U.S. Pat. Appl. Ser. No. 63/035,022, filed Jun. 5, 2020 pursuant to 35 U.S.C. §111(b), and entitled RESISTIVE FOIL HEATER, the disclosure of which hereby incorporated by reference in its entirety.

### TECHNICAL FIELD

The present invention is generally directed to a resistive foil heating, more particularly to resistive foil heaters per se and/or one or more of subassemblies, and/or structures thereof, including methods for/of making one or more of same, as the case may be, more particularly, the instant invention is advantageously, but not exclusively, directed to an improved fluorinated ethylene propylene (FEP) polyimide resistive foil heater.

### BACKGROUND

Flexible heaters are characterized by thin flexible heating elements, e.g., wire or etched foil elements. Such heaters are readily securable to items for the sake of imparting thermal energy thereto, for example, in furtherance of freeze protection, temperature maintenance, moisture control, and/or thermal control/regulation.

Etched or resistive foil heating elements are especially advantageous in that the fabrication process enables tight spacing control for the etched pattern. Fine precision conductive element (i.e., strand) width and spacing results in an advantageous relatively high density of conductive strands for the resistive foil heating element.

Especially thin, advantageous resistive foil heaters are characterized by polyimide (e.g., KAPTON) substrates, see e.g., Polyimide Thermofoil™ Heaters from Applicant Minco Products, Inc., MN, USA. Such heaters offer excellent temperature control and uniformity, with their thin profile effectuating fast warm up, consistent heat distribution and extended heater life. While applications generally include medical, industrial/commercial, electronics, and defense/military, the unique environmental challenges associated with aerospace applications (e.g., spacecraft, satellites, and instrument panels) are especially well suited for such heaters.

Generally, a thin foil, e.g., a 0.0005” nickel-chromium alloy foil, is bonded to the polyimide substrate via application of a thermosetting adhesive layer, e.g., fluorinated ethylene propylene (FEP). A heating element pattern is imaged and etched in respect to the foil so as to delimit the resistive heating element. Conductive transition tabs, e.g., nickel-cobalt ferrous alloy, are provided to conductively and mechanically link the resistive foil heating element, e.g., via pads thereof, to/with lead wires for the resistive foil heater. A dielectric covering, e.g., a polyimide coverlay, is adhesively affixed to the base laminate using the thermoplastic adhesive. The “stack” is suitably exposed to an appropriate pressing cycle, not inconsistent with a pressure cycle for fabrication of the base laminate, with a polyimide resistive foil heater so formed.

FIG. 1 schematically depicts, exploded section, a conventional stack up for a FEP polyimide resistive foil heater. The conventional heater H is characterized by a base structure (i.e., laminate) 9, conductive transition tabs 11, lead wires 13, a coverlay 15 and a FEP filler 17 for securing the coverlay to the base structure. The base structure is characterized by an etched foil heater 9a, with contacts pads 9b, and a polyimide substrate 9c supporting the heater, the heater being adhesively affixed to a top surface thereof via a FEP interface/bond, each conductive transition tab extending from contact pads of the etched foil heater for union with a lead wire. A supplemental anchor or reinforcement element 19 is commonly interposed between the lead wire and a portion of the coverlay.

Owing to the stack up nature of the polyimide resistive foil heater (i.e., its laminate structure), more particularly, the introduction of the thermoplastic adhesive/filler, limitations or constraints are realized in connection to one or more of resistive foil heater configuration or patterning, and/or resistive foil heater strand width, and/or spacing. Higher power heaters are yet to be reliably and repeatably fabricated owing to heating element “swim,” motion within the stack up. Infiltration of the thermoplastic filler, while functioning to secure the coverlay, is known to cause movement of the resistive heating element, with the stranding/stranding layout thereof susceptible to unwelcome alteration/degradation. Thus, it is believed desirable and advantageous to provide an improved FEP resistive foil heater, more particularly, an improved FEP resistive foil heater characterized by an alternate approach to conventional resistive foil heater stack ups and/or resistive foil heater fabrication in furtherance of providing an improved resistive foil heater characterized by heretofore unavailable power outputs.

### SUMMARY OF THE INVENTION

An improved resistive foil heater is notionally provided. The improved heater includes a coverlay, a base, an etched composite panel intermediate the coverlay and the base, transition tabs, and lead wires. The etched composite panel is characterized by a foil element, and a substrate for supporting the foil element, and the panel is adapted for passage of the transition tabs in furtherance of functional union with the lead wires. The foil element is characterized by an etched resistive foil heater, and associated transition pads. The transition tab is united to/with the transition pads of the foil element of the etched composite panel, the lead wires functionally united with the etched resistive foil heater via the transition tabs.

Advantageously, but not necessarily, the foil element of the etched composite panel is a first foil element, the etched composite panel comprising a second foil element. The substrate is intermediate the first and second foil elements. The second foil element is characterized by tabs and transition pads. The transition pads of the second foil element are linked to the transition pads associated with the etched foil heater via the transition tabs. More specific features and advantages obtained in view of the summarized features will become apparent with reference to the drawing figures and detailed description of the invention.

### BRIEF DESCRIPTION OF THE DRAWINGS

All figures have been prepared, and are included to facilitate and/or enhance an understanding of the basic teaching of the contemplated embodiments, and/or the concepts underlying same, and are incorporated in and constitute a part of this specification. While the drawings illustrate embodiments and context with respect thereto, and together with the description serve to explain principles of embodiments, other embodiments and many of the intended advantages of the disclosed systems, subsystems, assemblies, subassemblies, apparatus, devices, mechanisms, methods, etc. will be readily appreciated as they become better understood by reference to the following detailed description and figures. It is to be noted that the elements of the drawings are not necessarily to scale relative to each other, with like reference numerals designating corresponding similar parts/structures.

FIGS. 1-13 are provided herewith wherein:

FIG. 1 schematically depicts, exploded section, a conventional stack up for a FEP polyimide resistive foil heater;

FIG. 2 schematically depicts, exploded section, an illustrative, non-limiting stack up for an improved FEP polyimide resistive foil heater;

FIG. 3 schematically depicts, exploded section, a further illustrative, non-limiting stack up for an improved FEP polyimide resistive foil heater, namely, a first adapted FIG. 2 FEP polyimide heater;

FIG. 4 schematically depicts, exploded section, a further illustrative, non-limiting stack up for an improved FEP polyimide resistive foil heater, namely, a second adapted FIG. 2 FEP polyimide heater;

FIG. 5 schematically depicts, exploded section, a further illustrative, non-limiting stack up for an improved FEP polyimide resistive foil heater, namely, a third adapted FIG. 2 FEP polyimide heater;

FIG. 6 schematically depicts, exploded section, a further illustrative, non-limiting stack up for an improved FEP polyimide resistive foil heater, namely, a FIG. 5 FEP polyimide heater variant;

FIG. 7 schematically depicts, exploded section, a further illustrative, non-limiting stack up for an improved FEP polyimide resistive foil heater, namely, a further FIG. 5 FEP polyimide heater variant;

FIG. 8 schematically depicts, exploded section, a further illustrative, non-limiting stack up for an improved FEP polyimide resistive foil heater, namely, a fourth adapted FIG. 2 FEP polyimide heater;

FIG. 9 schematically depicts, exploded section, a further illustrative, non-limiting stack up for an improved FEP polyimide resistive foil heater, namely, a fifth adapted FIG. 2 FEP polyimide heater;

FIG. 10 schematically depicts, exploded section, a further illustrative, non-limiting stack up for an improved FEP polyimide resistive foil heater, namely, a sixth adapted FIG. 2 FEP polyimide heater;

FIG. 11 depicts, plan view, a representative, non-limiting etched composite panel, first surface (i.e., “lower” surface), characterized by an etched foil heater with/and associated contact pads;

FIG. 12 depicts, plan view, the etched composite panel of FIG. 11, second surface (i.e., “upper” surface), characterized by tabs and associated contact pads; and,

FIGS. 13A, 13B & 13C, depict, plan view, etched composite panel surfaces (FIGS. 13A & 13B), not inconsistent with FIGS. 11 & 12, of a contemplated non-limiting FEP polyimide resistive foil heater (FIG. 13C), in keeping with the stack up of FIG. 2.

### DETAILED DESCRIPTION OF THE INVENTION(S)

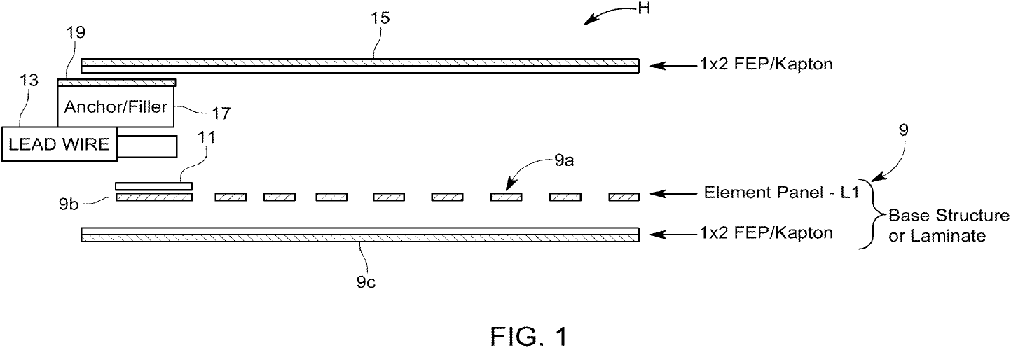

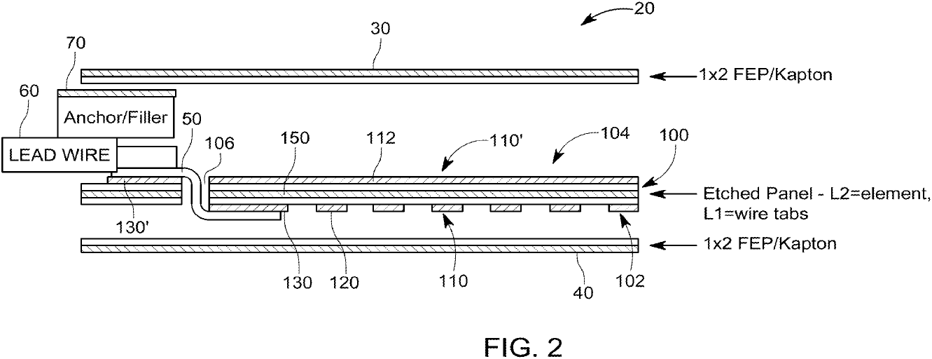

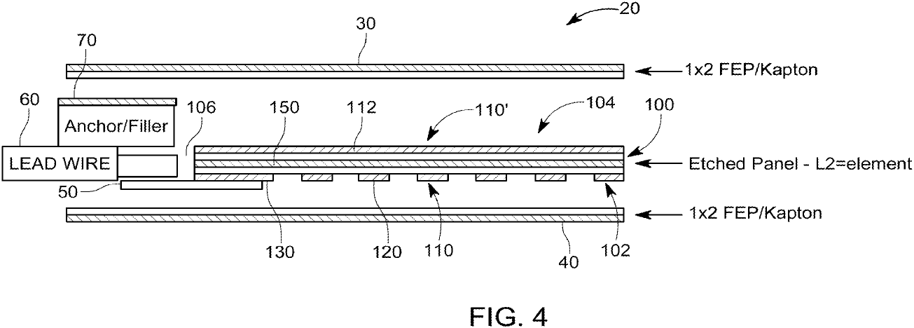

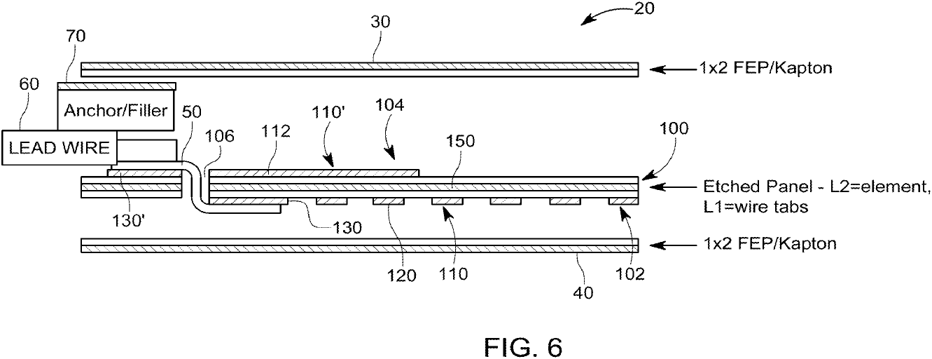

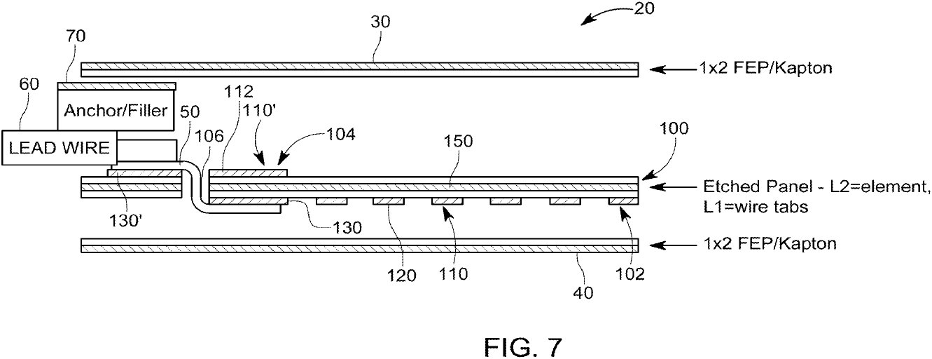

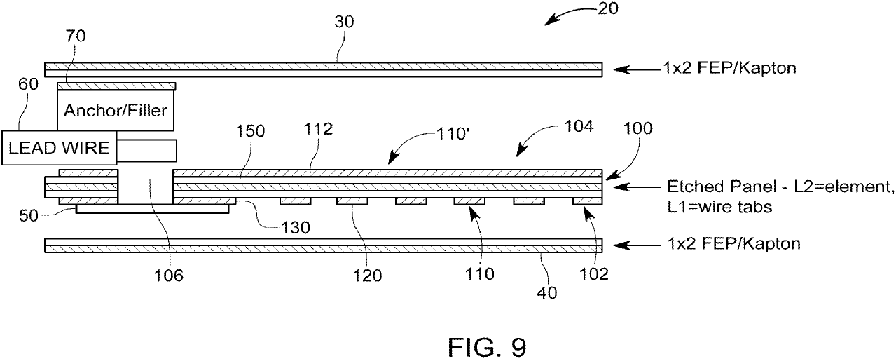

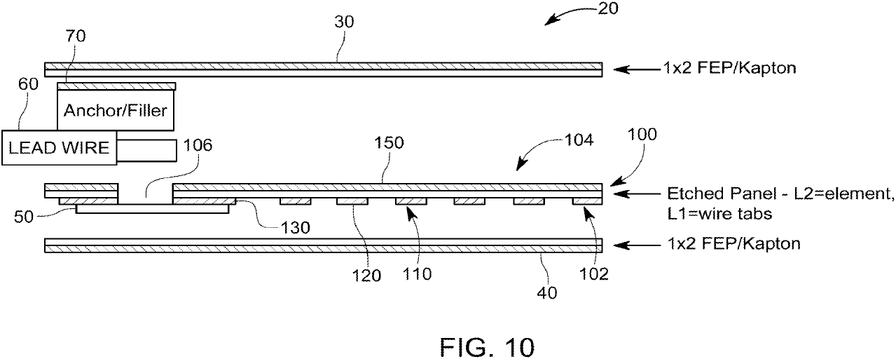

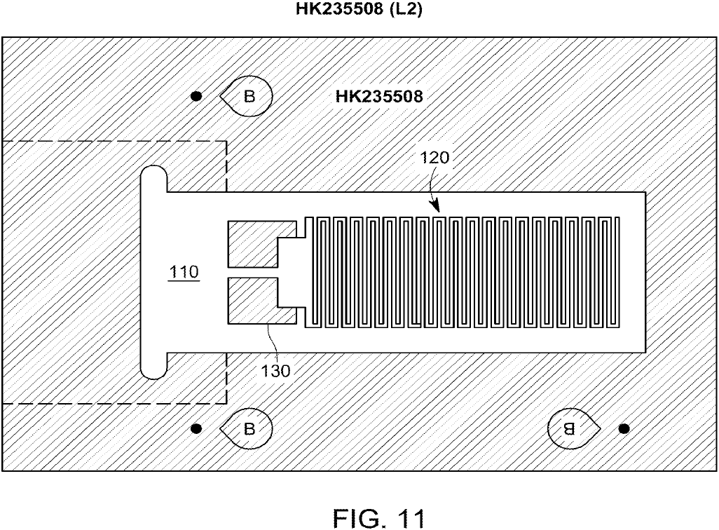

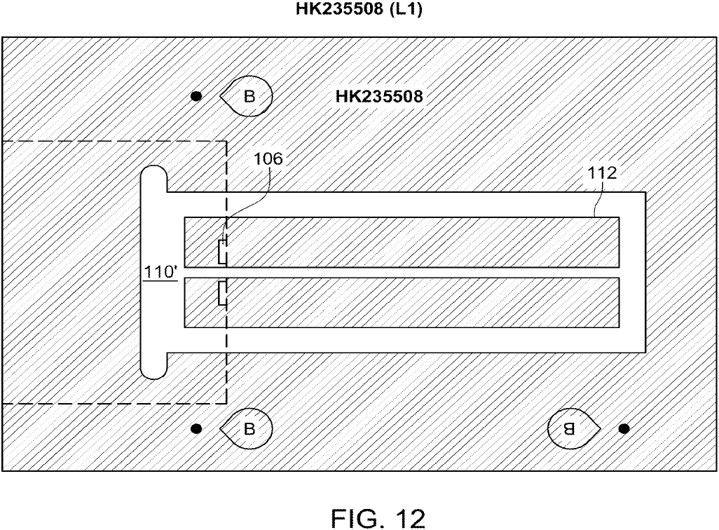

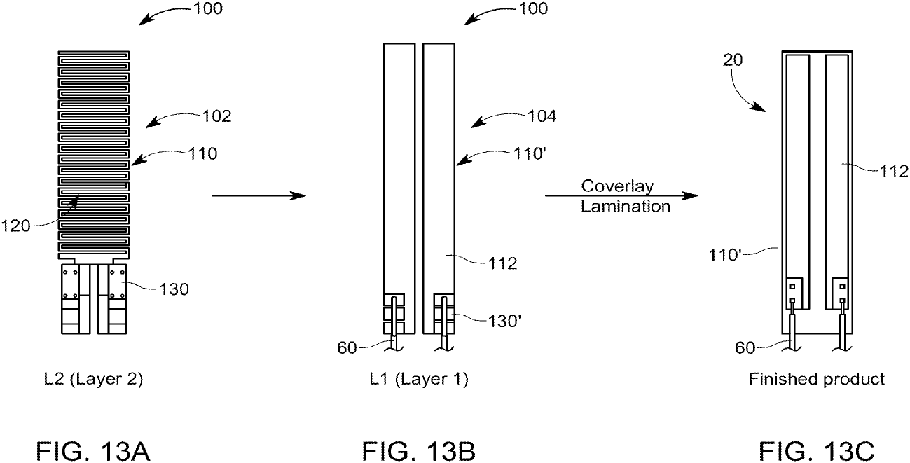

Non-limiting, resistive foil heater stack ups associated with Applicant’s contemplated, advantageous and novel resistive foil heaters are generally illustrated in respect of FIGS. 2-10, each a departure relative to the conventional stack up and resulting device of FIG. 1. Select stack up elements or components are generally depicted in respect of FIGS. 11, 12, 13A & 13B, with a resistive foil heater characterized by the FIGS. 13A & 13B components depicted in respect of FIG. 13C. In-as-much as representative component materials are/will be referenced, or even designated, e.g., FEP, KAPTON, as have may been previously referenced, the improved resistive foil heaters need not be so characterized nor limited. In advance of the taking up of the drawing depictions and description of the contemplated, advantageous resistive foil heaters, some initial observations are worthwhile.

Notionally, the resistive foil heating element of the contemplated resistive foil heaters is supported and/or guarded or protected via its inclusion in an etched panel, and/or its select isolation/distancing from the thermoplastic filler material to eliminate a “swim” scenario. Via isolation of lead wire connections from the resistive foil heating element, as by advantageous provisions for/inclusion of a tabbed element (e.g., lamina) which functions to, among other things, proved improved clamp down during lamination, advantageously in the form of a surface of an etched composite panel intermediate a base and coverlay, or as by alternate tabbed unions of the resistive foil heating element with the lead wires, a swim condition for the resistive foil heating element is avoided.

Applicant’s preferred, non-limiting approach for the improved resistive foil heater, among other embodiments, is generally and fairly characterized by inclusion of a structure (e.g., a composite structure) intermediate the coverlay and base of the heater, namely, an etched panel/composite panel. A resistive foil of one side of a substrate of the panel, i.e., a first surface, is selectively etched to delimit/form a heating element and transition or contact pad. A resistive foil of the other side of the panel substrate, i.e., a second surface, is selectively etched to delimit/form tabs and/or transition or contact pads. The resulting etched composite panel is advantageously adapted, as by, for example, slitting, slotting, etc. to permit passage of transition tabs. The transition tabs are operatively united, as by, for example welding, to the pads of the first and second etched surfaces of the etched composite panel, with the lead wires operatively united to the wire transition or contact pads of the second surface of the etched composite panel. Thereafter, the coverlay and FEP thermoplastic filler are suitably introduced/laminatingly added or joined to the subassembly characterized by, among other things, the adapted etched composite panel in furtherance of fabricating an improved resistive foil heater.

With reference now to all illustrative the resistive foil stack ups of each of FIGS. 2-10, there is generally shown a resistive foil heater 20, exploded section schematic, characterized by a coverlay 30, a base 40, an etched composite panel 100 intermediate the coverlay and the base, transition tabs 50, and lead wires 60. Notionally, the transition tabs, offset or spaced apart in the z-axis in relation to the lead wires, isolate and/or buffer the etched resistive foil heating element from the lead wires in the stack up to effectuate a reliable union without misalignment/swim of the heating element. A reinforcement element, e.g., an anchor 70 as shown, may be suitably incorporated into the heater so as to be interposed between the coverlay and the lead wires.

The etched composite panel is characterized by first (i.e., lower) and second (i.e., upper) surfaces 102, 104. As indicated, lower surface 102 of the etched composite panel comprises a foil layer or element 110 upon a substrate 150 for supporting the foil layer. Foil layer 110 is characterized by an etched resistive foil heater 120 and associated transition pads 130, transition tabs 50 are united to transition pads 130 of foil layer 110 of etched panel 100, with lead wires 60 functionally united with etched resistive foil heater 120 via transition tabs 50.

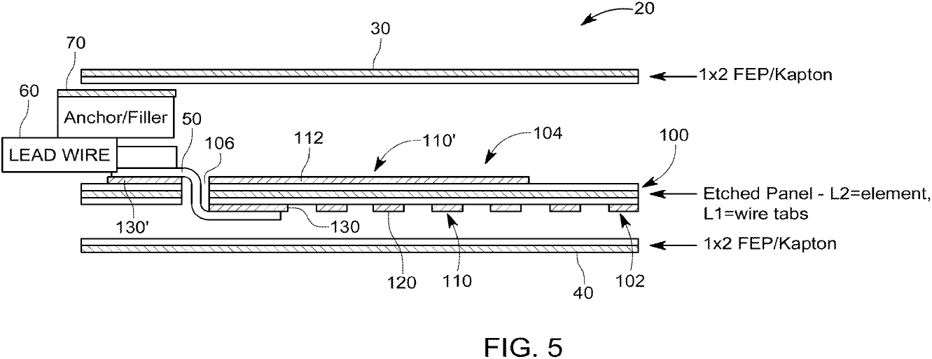

With particular reference now to the resistive foil heater depictions of FIGS. 2-9, foil layer or element 110 of etched composite panel 100 is a first foil layer, etched composite panel 100 further, advantageously but not necessarily, including a second foil layer or element 110′, substrate 150 intermediate first and second foil layers, 110, 110′. Second foil layer is characterized by tabs 112 and transition pads 130′ linkable/linked to transition pads 130 associated with etched foil heater 120 via transition tabs 50. Notionally, the etched composite panel is adapted, for example slotted or slit (i.e., adapted so as to include passageways, e.g., slots/slits 102 or the like as shown), for passage of transition tabs 50 in furtherance of functional union with lead wires 60. Advantageously, a length of tabs of the second foil layer approximates a length of the substrate of the etched panel, however, its length may be less than the length of the substrate, for instance, its length may suitably be a fraction thereof, e.g., three quarters, one half, and one quarter as shown in each of FIGS. 5-7.

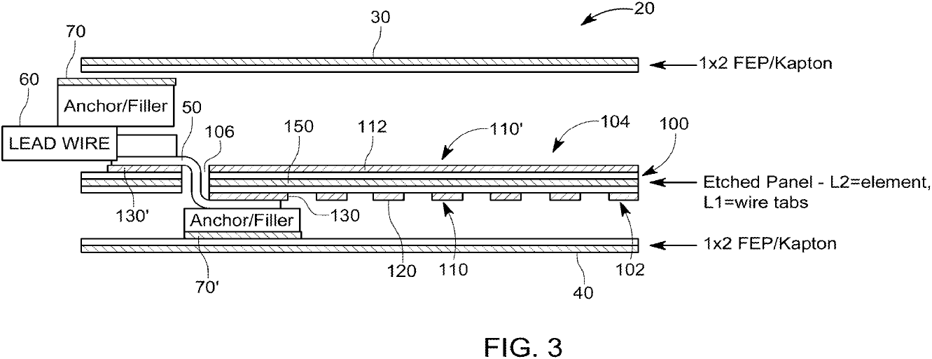

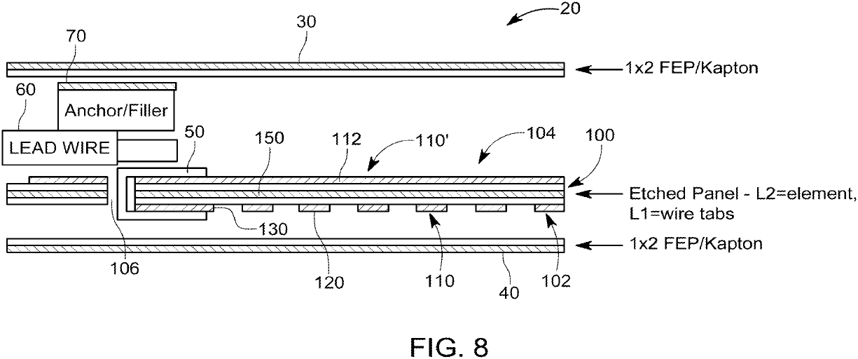

A further reinforcement element, e.g., an anchor 70′ as shown (FIG. 3), may be suitably incorporated into the heater so as to be interposed between the base and the unions of the transition tabs with the transition pads of the foil layer of the etched composite panel. Without limitation, a 1mil FEP/2 mil Kapton anchor is believed advantageous. Moreover, as heating applications may dictate (i.e., as etched resistive foil heating element configuration/layout may require), each of the transition tabs may advantageously fold back upon itself (FIG. 8), assuming a “C” configuration as shown.

With reference now to FIG. 11-13C, there is shown illustrative, non-limiting photoresist renderings of foil elements of/for the etched composite panel corresponding to first and second foil elements respectively, FIGS. 11 & 12, the etched composite panel, plan views, provided in respect of FIGS. 13A & 13B corresponding to the foil elements of FIGS. 11 & 12 respectively, and an improved FEP polyimide resistive foil heater so characterized, plan view “top,” FIG. 13C. Reference characters are supplied not inconsistent with their use in respect of, for instance, FIG. 2.

What has been described and depicted herein are preferred, non-limiting embodiments of Applicant’s subject matter, along with some application contexts. Since the elements of the system and/or structures of the assemblies, subassemblies, and/or mechanisms disclosed herein may be embodied in other specific forms without departing from the spirit or general characteristics thereof, some of which forms have been indicated, the embodiments described and depicted herein/with are to be considered in all respects illustrative and not restrictive. Accordingly, the scope of the subject invention is as defined in the language of the appended claims, and includes not insubstantial equivalents thereto.

What is claimed is:

1. A resistive foil heater comprising a coverlay, a base, an etched composite panel intermediate said coverlay and said base, transition tabs, and lead wires, said etched composite panel comprising a foil element and a substrate for supporting said foil element, said foil element characterized by an etched resistive foil heater and associated transition pads, said transition tab united to said transition pads of said foil element of said etched composite panel, said lead wires functionally united with said etched resistive foil heater via said transition tabs.

2. The resistive foil heater of claim 1 wherein said etched composite panel is adapted for passage of said transition tabs in furtherance of functional union with said lead wires.

3. The resistive foil heater of claim 1 wherein said foil element of said etched composite panel is a first foil element, said etched composite panel comprising a second foil element, said substrate intermediate said first and second foil elements.

4. The resistive foil heater of claim 1 wherein said foil element of said etched composite panel is a first foil element, said etched composite panel comprising a second foil element, said substrate intermediate said first and second foil elements, said second foil element characterized by tabs and transition pads, said transition pads of said second foil element linked to said transition pads associated with said etched foil heater via said transition tabs.

5. The resistive foil heater of claim 4 wherein a length of said tabs of said second foil element approximates a length of said substrate of said etched composite panel.

6. The resistive foil heater of claim 4 wherein a length of said tabs of said second foil element is less than a length of said substrate of said etched composite panel.

7. The resistive foil heater of claim 4 wherein a length of said tabs of said second foil element is about three quarters of a length of said substrate of said etched composite panel.

8. The resistive foil heater of claim 4 wherein a length of said tabs of said second foil element is about one half of a length of said substrate of said etched composite panel.

9. The resistive foil heater of claim 4 wherein a length of said tabs of said second foil element is about one quarter of a length of said substrate of said etched composite panel.

10. The resistive foil heater of claim 1 further comprising an anchor element interposed between said coverlay and said lead wires.

11. The resistive foil heater of claim 1 further comprising an anchor element interposed between said base and the union of said transition tabs with said transition pads of said foil element of said etched composite panel.

12. The resistive foil heater of claim 1 further comprising a first anchor element interposed between said coverlay and said lead wires and a second anchor element interposed between said base and the union of said transition tabs with said transition pads of said foil element of said etched composite panel.

13. A resistive foil heater comprising a coverlay, a base, an etched composite panel intermediate said coverlay and said base, transition tabs, and lead wires, said etched composite panel comprising a first foil layer, a second foil layer, and a substrate intermediate said first and said second foil layers, said first foil layer characterized by an etched resistive foil heater and associated transition pads, said second foil layer characterized by tabs and associated transition pads, said etched composite panel characterized by passages through which said transition tabs are passed, each of said transition tabs united to first and second transition pads of each of said first and second foil layers of said etched composite panel, said lead wires functionally united with said etched resistive foil heater via said transition tabs uniting first and second transition pads of each of said first and second foil layers of said etched composite panel.
